(19) United States
(12) Patent Application Publication
(10) Pub. No.: US 2010/0264343 A1
(43) Pub. Date: Oct. 21, 2010

(54) CONNECTORS AND VALVES

(76) Inventor: James Jeory, Preston (GB)

Correspondence Address: GAUTHIER & CONNORS, LLP, 225 FRANKLIN STREET, SUITE 2300, BOSTON, MA, 02110, US

(21) Appl. No.: 12/759,225

(22) Filed: Apr. 13, 2010

Related U.S. Application Data
(63) Continuation of application No. 10/255,486, filed on Sep. 26, 2002, now abandoned.
Application No. 10/255,486 is a continuation of application No. 09/759,979, filed on Jan. 12, 2001, now abandoned.

(30) Foreign Application Priority Data
Dec. 22, 2000 (GB) 0031676.0

(51) Int. Cl. F16L 37/28; F16L 37/44

(52) U.S. Cl. 251/152; 251/142

(57) ABSTRACT

A combined connector and valve, for example, for connection of an air line to a source of compressed air or to a vacuum source (all for use in an hydraulic fluid line) the connector comprising a one piece housing (112) a spring-loaded valve member (130) located in a bore (118) in the housing. The valve member (130) is removably retained in the bore by means of a threadedly engaged cap (134). A standard spring-loaded sleeve (140) is slidably located on the open end of the housing (112) to provide a means of connection, and a standard ribbed stem (114) may receive a hose at the remote end. The valve cap (134) has surface formations to enable it to be unthreaded from within the connector for retrieval of the valve member (130) for maintenance or replacement

### PRIORITY INFORMATION

This application claim is a continuation of U.S. patent application Ser. No. 10/255,486 filed on Sep. 26, 2002, which is a continuation of U.S. patent application Ser. No. 09/759,979 filed on Jan. 12, 2001 and which claims priority to GB Patent Application No. 0031676.0 filed on Dec. 22, 2000, all of which are incorporated herein by reference in their entirety.

### BACKGROUND OF THE INVENTION

However, a connector according to the present invention can also be used to connect an air line to a source of compressed air or to a vacuum source, or used in a hydraulic fluid line.

When a connector is to be used in a vacuum line it is particularly important to ensure that the number of leak paths is reduced as far as possible.

Known connectors usually have a body which is formed in two parts in order to allow a spring-loaded valve member to be located in one of the parts of the body and then the two parts of the body are attached together usually by a threaded connection. Even if this screw thread is sealed in some way it remains a potential leak path.

To avoid such a leak path, the present invention seeks to provide a connector having a body of a unitary construction including a hose tail.

The present invention further seeks to provide a connector in which the valve member can be readily removed and replaced.

According to the present invention there is provided, a unitary connector and valve, the connector comprising a single-component tubular housing defining a bore axially extending through the housing from end-to-end thereof, a spring-loaded valve member located wholly within the bore, and a cap providing a valve seat to be sealingly engaged by the valve member, the cap being located wholly within the bore and sealed therein against fluid passage through the bore around the cap, the cap being formed to receive a removal tool to be passed along the bore for removal of the cap through the bore.

The cap may be threadedly engaged within the bore of the housing.

The bore in the housing may have a first bore portion in which the valve member is located and a second bore portion in which the cap is located.

The first bore portion can have a threaded length, engageable by a threaded length of the cap.

An elongate part of the valve member may extend through a bore in the cap when the valve member is seated.

### BRIEF DESCRIPTION OF THE DRAWINGS

The present invention will now be described for illustrative but not limitative purposes, according to its preferred embodiments, with particular reference to the figures of the enclosed drawings, wherein:

FIG. 1 shows, in cross section, one form of the assembled line connector and valve.

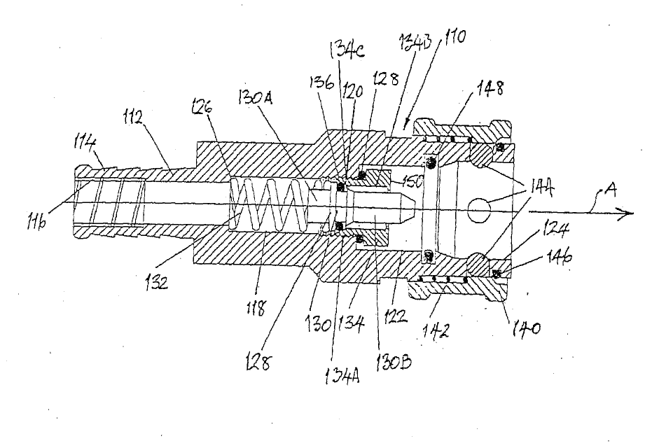

### DETAILED DESCRIPTION OF THE INVENTION

Referring to the drawing, there is shown a unitary connector and valve (110) comprising a housing (112) and a serrated hose tail (114) having a bore (116).

The housing has three main internal bores, the smallest diameter bore being a smooth bore (118) having a threaded length (120) a slightly larger smooth bore (122), and a bore (124) which is the largest in diameter.

A shoulder (126) is formed between the bores (116) and (118) and supports one end of a spring (132).

A valve member (130) having a spindle (130A) is located in the bore (118) and has a shoulder (128) supporting the other end of the spring (132).

The spring (132) is located around spindle (130A) of the valve member (130) and urges the latter in the direction of arrow A in the drawing.

The valve member (130) is retained in position by means of a valve cap (134) which has a screw threaded length (134A) engaging the threaded length (120) of the bore (118). An O-ring (128) forms a seal between the valve cap (134) and the housing (112).

The valve cap (134) has internal bore (134B) which terminates in a conical valve seat (134C), through which a probe (130B) of the valve member (130) protrudes.

The valve member (130) is provided with an 0-ring (136) so as to seal the valve member against the valve seat (134C).

The connector has a connecting sleeve (140) of a standard form which houses a spring (142) and ball bearings (144), the sleeve being retained by a ring or cir-clip (146).

The bore (124) also is provided with a seal (148) so as to sealingly engage with any connector inserted into the bore (124).

The valve cap (134) has radially extending slots or other formations on its front face (150) to receive a removal tool whereby the cap (134) may be unthreaded and removed to permit retrieval of the valve member (130).

It will be appreciated that as the housing (112) is a unitary construction a leak path has been removed as compared with the known two component valve housings. Also the unitary design enables the valve member to be introduced through the front of the connector, rather than the rear. To introduce the valve member from the rear would means that the hose tail would have to be a separate component leading to another potential leak path.

The provision of the valve cap (134) allows for easy assembly of the valve member within the housing and replacement and maintenance of the valve member when required.

In the case of known connectors the valve members are usually held in place by cir-clips and it is often extremely difficult or even impossible to remove them when maintenance or replacement is required, resulting in the whole connector having to be replaced. In the case of the connector according to the present invention the valve member and any other component can be readily replaced and the connector re-used.

What is claimed:

1. (canceled)

2. A connector according to claim 7, wherein the cap is threadedly engaged within the bore of the housing.

3. A connector according to claim 7, wherein the bore in the housing has a first bore portion in which the valve member is located and a second bore portion in which the cap is located.

4. A connector according to claim 3, in which the first bore portion has a threaded length engageable by a threaded length of the cap.

5. (canceled)

6. A connector according to claim 7, wherein the cap has an internal bore and the valve member has an elongate part which extends through the bore in the cap when the valve member is seated.

7. A unitary connector and valve, the connector comprising a single-component tubular housing defining a bore axially extending through the housing from end-to-end thereof, a spring-loaded valve member located wholly within the bore, and a cap providing a valve seat to be sealingly engaged by the valve member, the cap being located wholly within the bore and sealed therein against fluid passage through the bore around the cap, the cap being formed to receive a removal tool to be passed along bore for removal of the cap through the bore.

8. A connector according to claim 7, wherein the housing has an externally serrated hose tail at one end thereof, and spring-loaded connecting sleeve containing ball bearings retained in the opposite end region of the housing.
